(19) United States
(12) Patent Application Publication
(10) Pub. No.: US 2015/0052012 A1
(43) Pub. Date: Feb. 19, 2015

(54) METHODS, SYSTEMS, AND APPARATUS FOR CORRECTING AN ELECTRONIC COMMERCE LISTING

(71) Applicant: David Eramian, Mountain View, CA (US)

(72) Inventor: David Eramian, Mountain View, CA (US)

(73) Assignee: eBay Inc., San Jose, CA (US)

(21) Appl. No.: 13/965,679

(22) Filed: Aug. 13, 2013

(51) Int. Cl. G06Q 30/06

(52) U.S. Cl. CPC G06Q 30/0609
USPC 705/26.35

(57) ABSTRACT

Methods, systems, and apparatus for processing an error in an item listing are described. An error report from a reporting user of the item listing may be obtained. The error may be reported to an authorized user associated with the item listing. The error may be corrected by a reporting user, may be automatically corrected, or may be corrected by an authorized user associated with the item listing.

### TECHNICAL FIELD

The present application relates generally to electronic commerce, and more specifically, in one example, to correcting an electronic commerce item listing.

### BACKGROUND

Consumers are shopping online for a growing variety of products and services and may conduct searches to locate items that are available for purchase. Consumers of products and services may generally include retail consumers, distributors, small business owners, business representatives, corporate representatives, non-profit organizations, and the like. The providers of the products and/or services may include individuals, retailers, wholesalers, distributors, manufacturers, service providers, small business owners, independent dealers, and the like. The listing for an item that is available for purchase may include a price, a description of the product and/or service and, optionally, a picture of the item and one or more specific terms for the offer.

A search for a product and/or service may produce a list of available items for purchase. A consumer may evaluate the offers and may accept an offer, reject an offer, or discard an offer. In some instances, the item listing may contain one or more errors. The errors may range from minor spelling errors to major errors that may impact a consumer's decision to purchase an item. As a result, for example, the consumer may purchase an item and, after discovering the error in the item listing, then return the purchased item. The item purchased in error may therefore adversely impact the consumer, the seller and/or the electronic commerce provider.

### BRIEF DESCRIPTION OF THE DRAWINGS

Some embodiments are illustrated by way of example and not limitation in the figures of the accompanying drawings in which:

FIG. 1 is a block diagram of an example electronic commerce system, in accordance with an example embodiment, for searching for products and/or services;

FIG. 2 is a flowchart for an example electronic commerce method for listing, indexing, and searching for a product and/or service, in accordance with an example embodiment;

FIG. 3 is a block diagram of an example apparatus, in accordance with an example embodiment, for initiating and conducting a search for products and/or services and for reporting and/or correcting an error(s) in an item listing;

FIG. 4 is a representation of an example user interface for performing a search for a product and/or service and for reporting and/or correcting an error in an item listing, in accordance with an example embodiment;

FIG. 5 is a representation of an example user interface for reporting and/or correcting an error in an item listing, in accordance with an example embodiment;

FIG. 6 is a flowchart for an example user interface method, in accordance with an example embodiment;

FIG. 7 is a flowchart for an example method for reporting and/or correcting an error in an item listing, in accordance with an example embodiment;

FIG. 8 is a block diagram of an example apparatus 800, in accordance with an example embodiment, for performing a search for products and/or services; and

FIG. 9 is a block diagram of a machine within which instructions may be executed for causing the machine to perform any one or more of the methodologies discussed herein.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, methods, systems, and apparatus for reporting and/or correcting errors in item listings in an electronic commerce system are described. In one example embodiment, a consumer may conduct a search for an item, e.g. an item available for sale. As used herein, an “item” may refer to a product, a service, a combination of a product and a service, and the like. The search result set may produce a list of available items of varying degrees of relevance. The consumer may select one or more items in the search result set that may be of interest to the consumer and on which the consumer may desire to receive additional information and/or execute a transaction. The item listing may contain one or more errors that may adversely impact the consumer's ability to evaluate the item. In one example embodiment, the consumer may be offered the opportunity to identify and report a recognized error(s) in the item listing. In one example embodiment, the consumer may be offered the opportunity to correct a recognized error(s) in the item listing.

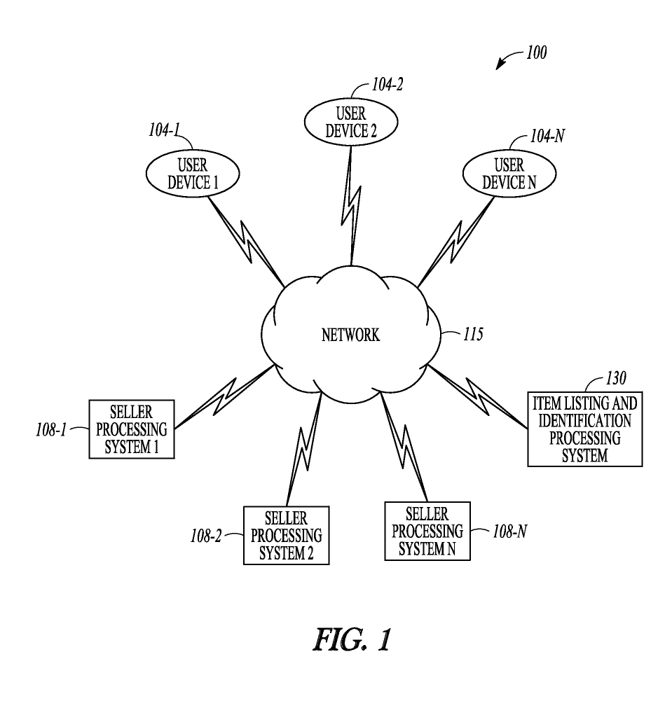

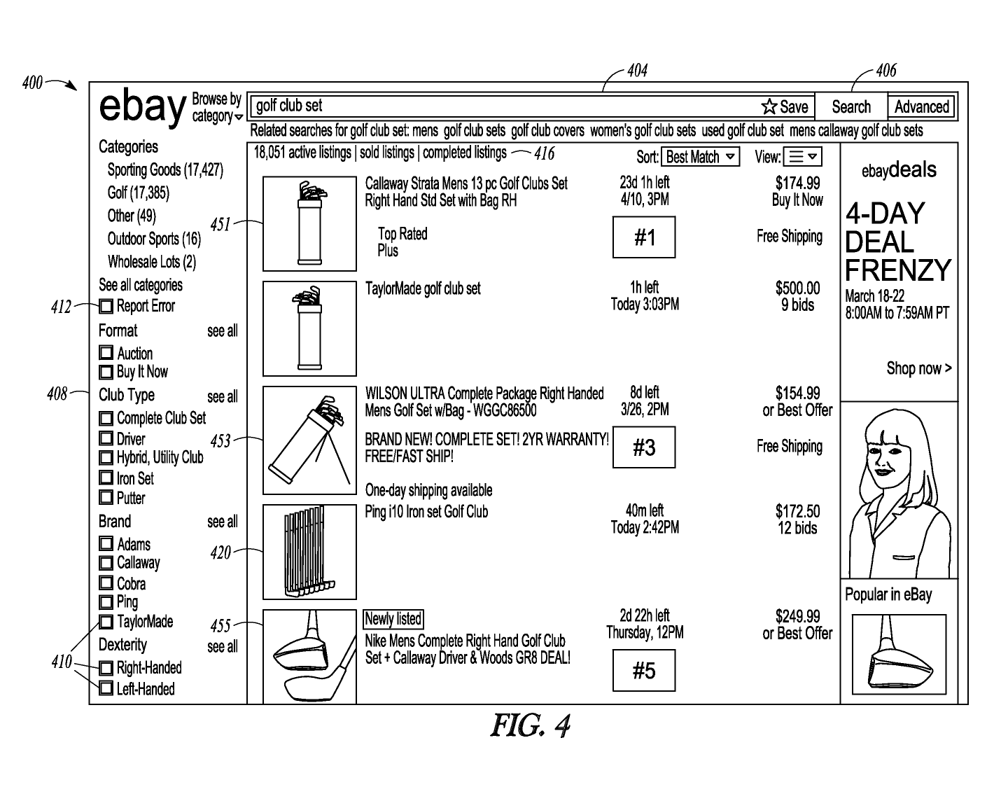

FIG. 1 is a block diagram of an example electronic commerce system 100, in accordance with an example embodiment, for searching for products and/or services. In one example embodiment, the system 100 may include one or more user devices 104-1, 104-2 and 104-N (known as user devices 104 hereinafter), one or more optional seller processing systems 108-1, 108-2 and 108-N (known as seller processing systems 108 hereinafter), an item listing and identification processing system 130, and a network 115. Each user device (e.g., 104-1) may be a personal computer (PC), a tablet computer, a mobile phone, a personal digital assistant (PDA), a wearable computing device (e.g., a smartwatch), or any other appropriate computer device. Each user device (104-1, 104-2 or 104-N) may include a user interface module 306, described more fully below in conjunction with FIG. 3. In one embodiment, the user interface module 306 may include a web browser program and/or an application, such as a mobile application. Although a detailed description is only illustrated for user device 104-1, it is noted that each of the other user devices (e.g., user device 104-2 through user device 104-N) may have corresponding elements with the same functionality.

The optional seller processing systems 108 and the item listing and identification processing system 130 may be a server, client, or other processing device that includes an operating system for executing software instructions. The optional seller processing systems 108 may provide items for sale to a consumer, and may facilitate the search for and purchase of the items to a variety of consumers.

The network 115 may be may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, a network of interconnected networks, or a combination of two or more such networks, and the like.

Each user device 104 may receive a query for item information from a user via an input device such as keyboard, touchscreen, microphone, mouse, electronic pen, etc. An item may include, for example, a product and/or a service and the corresponding information may be in the form of an item listing.

The item listing and identification processing system 130 of an online listing system may store and/or obtain information related to items available for sale. Each item listing may include a detailed description for the item, a picture of the item, attributes of the item, and the like. The item associated with the item listing may be a good or product (e.g., a tablet computer) and/or service (e.g., a round of golf or appliance repair) that may be transacted (e.g., exchanging, sharing information about, buying, selling, making a bid on, and the like). The item listing may also include a title, a category (e.g., electronics, sporting goods, books, antiques, and the like), and attributes and tag information (e.g., color, size, and the like).

Referring back to the user device 104-1, the query received from the user of user device 104-1 may include one or more keywords. The user device 104-1 may transmit the query to the item listing and identification processing system 130 via the network 115. The item listing and identification processing system 130 may attempt to match the query keywords with the title, the category, the tag information, and/or any other field in the item listing using a search engine.

In response to the submission of the search query, the item listing and identification processing system 130 may attempt to identify one or more item listings that satisfy the query. The item listing and identification processing system 130 may retrieve and then sort the item listings in the search result in a known manner. The item listing and identification processing system 130 may then return a sorted search result list to the user device 104-1 that submitted the query. The consumer may select one or more items in order to obtain additional information on the item and/or purchase the item.

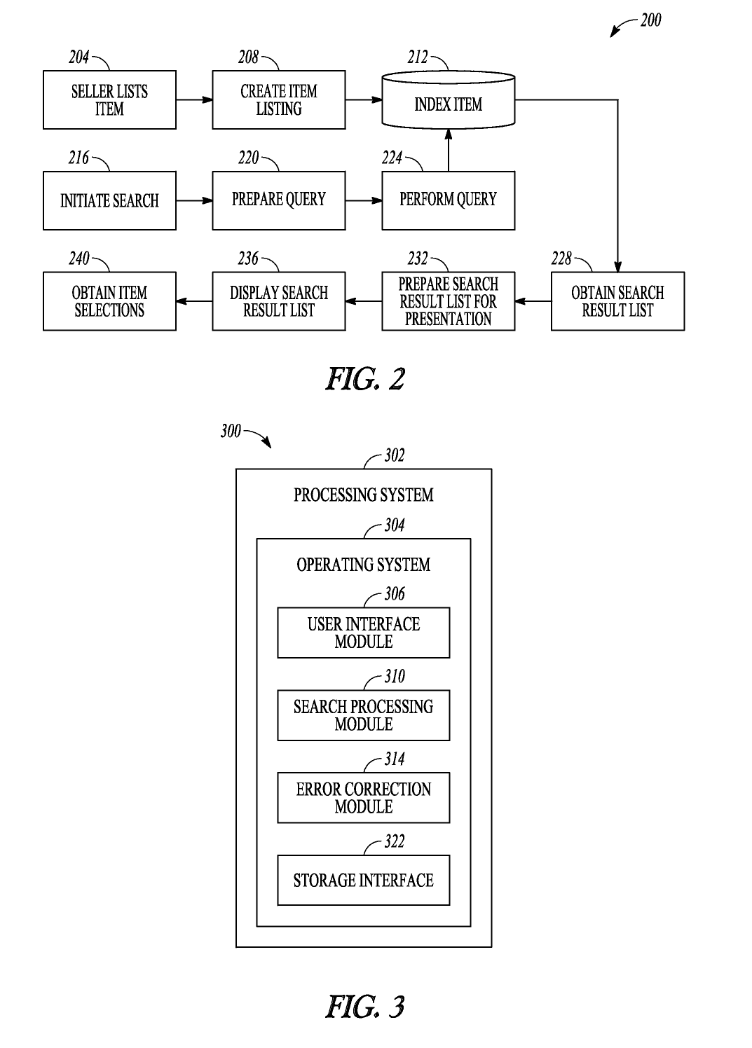

FIG. 2 is a flowchart for an example electronic commerce method 200 for listing, indexing, and searching for a product and/or service, in accordance with an example embodiment. In one example embodiment, a seller may list an item for sale (operation 204). The seller may, for example, select a category for the item, submit a description of the item, submit a picture of the item, manually set attributes of the item, and the like.

An item listing may be created, for example, in an item listing database (operation 208). The listing may include, for example, attributes of the item and terms of the sale offer. During the item listing operation 208, an identification number for the item listing may be assigned, and the listing may be authenticated and scanned to check for conformance with one or more listing policies. The listed item may be indexed (operation 212) in a known manner to facilitate future searches for the item.

A consumer may launch a search or query for one or more items (operation 216). For example, a consumer may initiate a search using the keywords “golf clubs.” A corresponding query may be prepared (operation 220). For example, a spell check may be performed on the query terms and a search expression may be generated based on the provided search terms.

The query may be executed on, for example, the items that have been indexed in the system (operation 224). For example, the prepared query may be matched against the index that was updated during operation 212.

In response to the execution of the query, a search result list may be obtained (operation 228). The search result list may be prepared for presentation (operation 232). For example, the search result list may be filtered, sorted, ranked and/or formatted based, for example, on an analysis of the search result list.

The prepared search result list may be displayed (operation 236). In response to reviewing the displayed search result list, one or more item selections from one or more displayed item pages may be obtained from a user (operation 240).

Upon reviewing an item listing, a user may recognize one or more errors in the item listing. The error may be a typographical error, an error in a specification of the item, an inaccuracy in the item listing, and the like.

In one example embodiment, the user device 104-1 may provide a mechanism for the user to identify and report the error. In one example embodiment, the user may enter a textual description of the error. In one example embodiment, a user may enter a verbal description of the error and the verbal description may be converted to text via, for example, speech recognition software to process the error report. In one example embodiment, the user may highlight the element in error using a mouse, trackpad, or other pointing device. In one example embodiment, the user may select the correct element from a drop-down menu. In one example embodiment, the user may use an editor to correct the error. For example, the user may use a text editor to delete an incorrect term and enter a correct term.

In one example embodiment, a consumer attempting to identify and report an error in an item listing may be authenticated prior to being allowed to report the error and/or prior to processing the reported error. For example, the user may enter a user identification code and password. In one example embodiment, a consumer may only be allowed to correct an error if the consumer is recognized by the system to be a trusted user. A trusted user, as used herein, may be a user whose previously reported errors have been validated, whose percentage of validated errors exceeds a trusted-level threshold, whose account is a validated account, and/or whose feedback score exceeds a trusted-level threshold.

In one example embodiment, an error reported for an item listing may be validated by the item listing and identification processing system 130. For example, the horsepower rating in an automobile listing may be compared to a list of available engine options for the year, make, and model of the automobile. If the horsepower rating in the listing is not one of the available engine options, the error may be validated.

In one example embodiment, a consumer attempting to identify and report an error in an item listing may be presented with a list of errors already reported for the selected item listing. If the error recognized by the consumer has already been reported, the consumer may save the effort of submitting a duplicate error report.

In one example embodiment, the item listing and identification processing system 130 may compare a reported error to previously reported errors for the item listing and the reported error may be filtered and/or blocked if the error has already been reported.

In one example embodiment, the error may be automatically corrected. For example, if the error is an unambiguous typographical error, the item listing and identification processing system 130 may automatically correct the error. In one example embodiment, the error may be reported to the seller and the seller may be responsible for correcting the error.

In one example embodiment, an item listing containing an error may be blocked from being displayed. For example, if an error in an item listing is deemed serious, the item listing and identification processing system 130 may automatically suspend the inclusion of the item listing in a search result list and/or suspend the displaying of the item listing to a user.

In one example embodiment, an item listing potentially containing an error may be marked as potentially containing an error. For example, the item listing in a database may be marked as potentially containing an error. In one example embodiment, the display of the item listing may also indicate that the item listing may contain a potential error. In one example embodiment, a display of the item listing may identify the potential error in the listing. For example, a term that may be in error may be highlighted in a particular color, may be displayed in a bold font, and the like.

In one example embodiment, the item listing may be displayed with the element in the item listing that is in error or is potentially in error being blocked from being displayed in the item listing. For example, if the horsepower rating in an item listing for an automobile is in error, the item listing may be displayed without the horsepower rating.

FIG. 3 is a block diagram of an example apparatus, in accordance with an example embodiment, for initiating and conducting a search for products and/or services, and for reporting and/or correcting an error(s) in an item listing. The apparatus 300 is shown to include a processing system 302 that may be implemented on a client or other processing device that includes an operating system 304 for executing software instructions.

In accordance with an example embodiment, the apparatus 300 may include a user interface module 306, a search processing module 310, and an error correction module 314. In accordance with an example embodiment, the apparatus 300 may further include a storage interface 322.

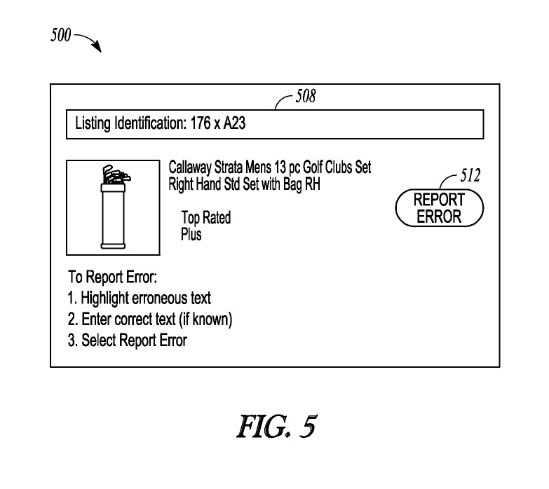

The user interface module 306 may obtain search criteria from a user (consumer), may present a search result list to a user, may obtain item selections from a user, may present an item listing to a user, and may present a mechanism for the user to report and/or correct an error in an item listing. The user interface module 306 may provide user interface 400 and user interface 500, as described more fully below in conjunction with FIGS. 4 and 5, respectively.

The search processing module 310 may submit a query to the item listing and identification processing system 130 and may obtain a search result list from the item listing and identification processing system 130.

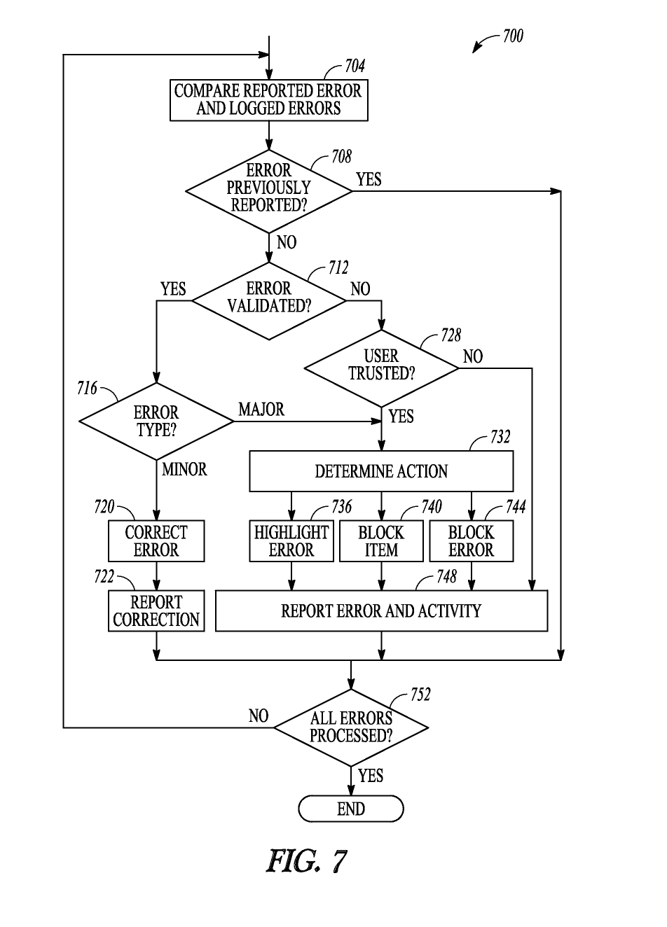

The error correction module 314 may enable a user to identify and report an error in an item listing, as described more fully above. In one example embodiment, the error correction module 314 may assist a user in reporting and/or correcting an error in an item listing. In one example embodiment, the error correction module 314 may correct a reported error. In one example embodiment, the error correction may be performed automatically by the error correction module 314. The error correction module 314 may perform a method 700 for reporting and/or correcting an error in an item listing, as described more fully below in conjunction with FIG. 7.

FIG. 4 is a representation of an example user interface 400 for performing a search for a product and/or service and for reporting an error in an item listing, in accordance with an example embodiment. In one example embodiment, the user interface 400 may be utilized by user device 104-1 to enable a user to conduct a search for an item and to report an error in the item listing.

In one example embodiment, one or more keywords may be entered in search field 404 and a search button 406 may be selected to initiate the search. The search may be constrained by the search filter settings identified by filter selection indicators 410 in a filter selection area 408. One or more items 420 may be displayed in a search result list area 416. In the example user interface 400, the items in search field 404 are a variety of sets of golf clubs. Golf sets 451, 453, 455 are right-handed golf sets.

In one example embodiment, if an error in the item listing is recognized by a user, the user may select the “Report Error” radio button 412 to report the error. In response, a user interface 500, such as a pop-up window, lightbox, new tab, etc., may be displayed which includes a representation of the item listing, as described more fully below in conjunction with FIG. 5.

FIG. 5 is a representation of an example user interface 500 for reporting and/or correcting an error in an item listing, in accordance with an example embodiment. In one example embodiment, the user interface 500 may be utilized by a user of user device 104-1 to report and/or correct an error in an item listing.

The user interface 500 may be, e.g., a pop-up window and may display a representation of an item listing. The user may select the element(s) in error using a pointing device, such as a trackpad, mouse, and the like. For example, if a word is misspelled, the user may highlight the misspelled word. In one example embodiment, the user may enter the correct spelling of the word. In one example embodiment, a drop-down menu may be used to select a correct element. For example, a user may select a characteristic of an item from a drop-down menu. If a listing for a particular model and year of a car lists an incorrect horsepower rating, the user may enter the correct horsepower rating, or may select the correct horsepower rating from a drop-down menu. The error report may then be processed and/or stored for future processing by selecting the report error radio button 512.

In one example embodiment, a list of previously reported errors for the corresponding listing may be presented to the user in the user interface 500. The user may abort a reporting of the error if the error is included in the cited list.

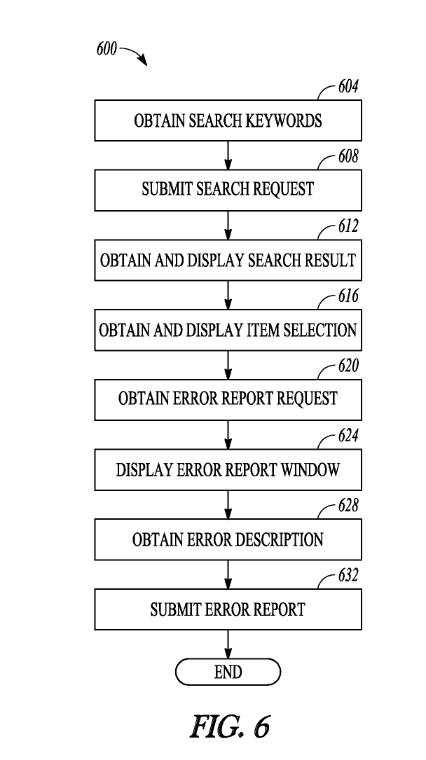

FIG. 6 is a flowchart for an example user interface method 600, in accordance with an example embodiment. In one example embodiment, one or more of the operations of the user interface method 600 may be performed by the user device 104-1.

One or more keywords may be obtained from a user initiating a search for a product and/or service via the input search field 404 (operation 604). The search may be submitted (operation 608) and a search result list may be obtained and displayed in the search result list area 416 (operation 612). One or more item selections from the search result list area 416 may be obtained from a user and displayed (operation 616). If an error in the item listing is recognized by a user, the user may select the “report error” radio button 412; the selection of the “report error” radio button 412 may be detected and an error report request may be obtained (operation 620). In response, the user interface 500 may be displayed (operation 624). A description of the error may be obtained from the user (operation 628), as described above in conjunction with FIG. 5. In one example embodiment, the user interface 500 may only be displayed if the user is authenticated and, optionally, may only be displayed if the user is a trusted user. The error report may be submitted to, for example, the item listing and identification processing system 130 (operation 632), as described below in conjunction with FIG. 7.

FIG. 7 is a flowchart for an example method 700 for reporting and/or correcting an error in an item listing, in accordance with an example embodiment. In one example embodiment, one or more of the operations of the method 700 may be performed by the item listing and identification processing system 130 and/or the error correction module 314.

In one example embodiment, one or more errors corresponding to an item listing reported by a user may be compared to errors previously reported for the item listing (operation 704). A test may be performed to determine if a presently reported error corresponding to the item listing has been previously reported (operation 708). If the error corresponding to the item listing has been previously reported, the method may proceed with operation 752; otherwise, a test may be performed to determine if the error may be validated (operation 712).

If the error is validated, a test may be performed to determine the type of error (operation 716). If the error is minor, the error may be automatically corrected (operation 720). For example, if the error is a spelling error and the severity of the error is below a severity threshold value, the error may be automatically corrected. The error and automatic correction may be reported to, for example, the author and/or owner of the item listing (operation 722) and the method may proceed with operation 752.

If the error is not validated, a test may be performed to determine if the user reporting the error is a trusted user (operation 728). If the user is not a trusted user, the error may be reported to, for example, the author and/or owner of the item listing (operation 748) and the method may proceed with operation 752.

If the error is major (as determined by operation 716) and/or the user is trusted (as determined by operation 728), a determination of the type of action to execute may be made (operation 732). For example, the type of action may be predefined, may be based on an analysis of the error, may be based on the total number of errors discovered in the item listing, may be based on the profile of the author and/or owner of the item listing, may be based on the severity of the error, and the like. In one example embodiment, the error or potential error in the item listing may be highlighted in the item listing (operation 736). In one example embodiment, the item listing containing the error or potential error may be blocked from being included in a search result list and/or may be blocked from being displayed to a user in a search result list (operation 740). In one example embodiment, the error or potential error in the item listing may be blocked from being displayed in the item listing (operation 744). For example, an item listing may be blocked if a severe error(s) is detected or if an error count in the item listing exceeds an error count threshold. In another example, an error in an item listing may be blocked if the authorized user associated with the item listing is identified as a trusted user.

The error and corresponding action taken (if any) may be reported to, for example, the author and/or owner of the item listing (operation 748) and the method may proceed with operation 752.

During operation 752, a test may be performed to determine if all errors have been processed. If all errors have not been processed, the method may proceed with operation 704; otherwise, the method may end.

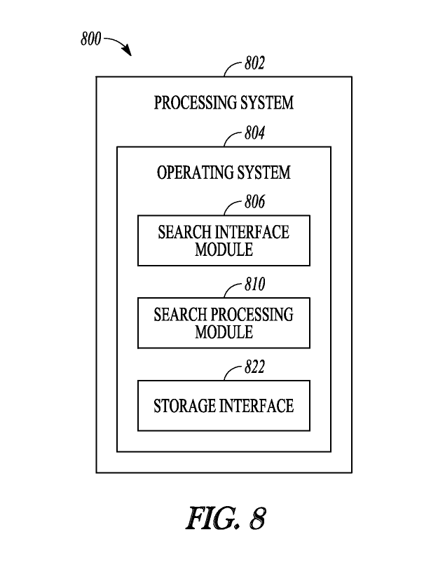

FIG. 8 is a block diagram of an example apparatus 800, in accordance with an example embodiment, for performing a search for products and/or services. The apparatus 800 is shown to include a processing system 802 that may be implemented on a client or other processing device that includes an operating system 804 for executing software instructions. In accordance with an example embodiment, the apparatus 800 may include a search interface module 806, and a search processing module 810. In accordance with an example embodiment, the apparatus 800 may further include a storage interface 822. In one example embodiment, the apparatus 800 may be a component of the item listing and identification processing system 130.

The search interface module 806 may obtain search terms and consumer filter selections from the user device 104-1, may provide a search result list to the user device 104-1, and may obtain consumer item selections from the user device 104-1. The search processing module 810 may conduct a search for items in a known manner based on the search terms and consumer filter selections from the user device 104-1, and may generate the search result list for the user device 104-1. The storage interface 822 may provide access to databases containing item listings. For example, the storage interface 822 may provide access to storage listings within seller processing systems 108.

Although certain examples are shown and described here, other variations exist and are within the scope of the invention. It will be appreciated by those of ordinary skill in the art that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network 115 (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

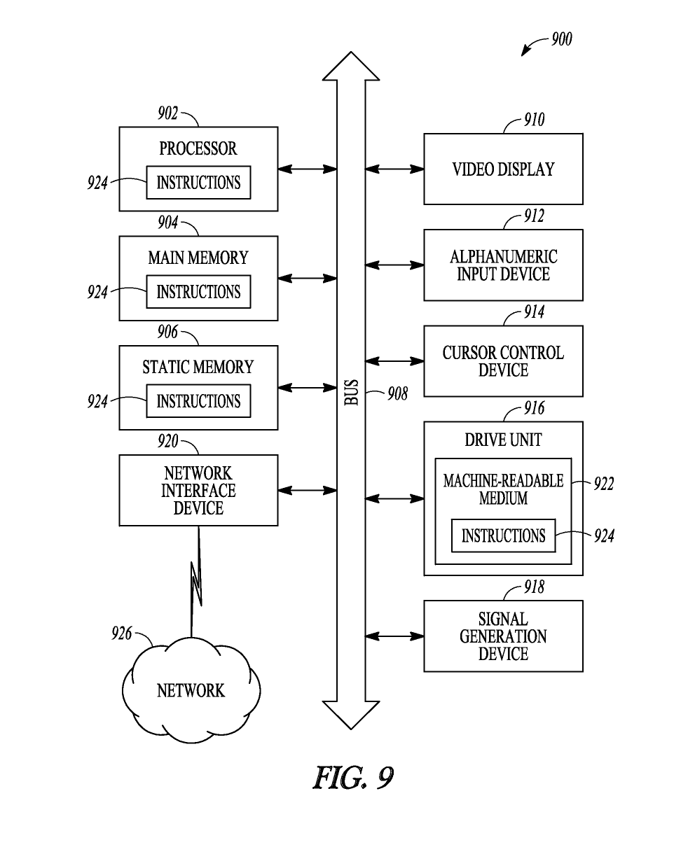

FIG. 9 is a block diagram of a machine within which instructions may be executed for causing the machine to perform any one or more of the methodologies discussed herein. In one example embodiment, the machine may be the example apparatus 300 of FIG. 3 for initiating and conducting a search for products and/or services, and for reporting and/or correcting an error(s) in an item listing. In one example embodiment, the machine may be the example apparatus 800 of FIG. 8 for performing a search for products and/or services. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

### Machine-Readable Medium

The drive unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media. Instructions may also reside within the static memory 906.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures 924. The term “machine-readable medium” shall also be taken to include any tangible medium that is capable of storing, encoding or carrying instructions 924 for execution by the machine and that cause the machine to perform any one or more of the methodologies of the present invention, or that is capable of storing, encoding or carrying data structures utilized by or associated with such instructions 924. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 924 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus to process an error in an item listing, the apparatus comprising:
a processor;
memory to store instructions that, when executed by the processor, cause the processor to:
obtain an error report from a reporting user of the item listing; and
report the error to an authorized user associated with the item listing.

2. The apparatus of claim 1, further comprising instructions that, when executed by the processor, cause the processor to validate the error.

3. The apparatus of claim 2, further comprising instructions that, when executed by the processor, cause the processor to evaluate a severity of the validated error.

4. The apparatus of claim 3, further comprising instructions that, when executed by the processor, cause the processor to:
compare the severity of the validated error and a severity threshold value; and
correct the reported error if the severity of the validated error is less than the severity threshold value.

5. The apparatus of claim 1, further comprising instructions that, when executed by the processor, cause the processor to determine a trust level of the reporting user.

6. The apparatus of claim 1, further comprising instructions that, when executed by the processor, cause the processor to block an item listing based on one or more of a severity of the reported error and a trust level of the reporting user.

7. The apparatus of claim 1, further comprising instructions that, when executed by the processor, cause the processor to block an element in an item listing based on one or more of a severity of the reported error and a trust level of the reporting user, the element corresponding to one of an error and a potential error.

8. The apparatus of claim 1, further comprising instructions that, when executed by the processor, cause the processor to highlight an element in an item listing based on one or more of a severity of the reported error and a trust level of the reporting user, the element corresponding to one of an error and a potential error.

9. The apparatus of claim 1, wherein the error is reported via one or more of: a textual description of the error, a highlighting of the error, and a correction of the error.

10. The apparatus of claim 1, wherein the error is corrected via one or more of: a text editor and a drop-down menu.

11. The apparatus of claim 1, further comprising instructions that, when executed by the processor, cause the processor to present a list of previously reported errors for the item listing.

12. The apparatus of claim 1, further comprising instructions that, when executed by the processor, cause the processor to block a reporting of an error if the reported error is included in a list of previously reported errors.

13. The apparatus of claim 1, further comprising instructions that, when executed by the processor, cause the processor to report the error to an authorized user associated with the item listing.

14. A method to process an error in an item listing, the method comprising:
obtaining an error report from a reporting user of the item listing; and
reporting the error to an authorized user associated with the item listing.

15. The method of claim 14, further comprising validating the error.

16. The method of claim 15, further comprising evaluating a severity of the validated error.

17. The method of claim 16, further comprising:
comparing the severity of the validated error and a severity threshold value; and
correcting the reported error if the severity of the validated error is less than the severity threshold value.

18. The method of claim 14, further comprising determining a trust level of the reporting user.

19. The method of claim 14, further comprising blocking an item listing based on one or more of a severity of the reported error and a trust level of the reporting user.

20. The method of claim 14, further comprising blocking an element in an item listing based on one or more of a severity of the reported error and a trust level of the reporting user, the element corresponding to one of an error and a potential error.

21. The method of claim 14, further comprising highlighting an element in an item listing based on one or more of a severity of the reported error and a trust level of the reporting user, the element corresponding to one of an error and a potential error.

22. The method of claim 14, wherein the error is reported via one or more of: a textual description of the error, a highlighting of the error, and a correction of the error.

23. The method of claim 14, wherein the error is corrected via one or more of: a text editor and a drop-down menu.

24. The method of claim 14, further comprising presenting a list of previously reported errors for the item listing.

25. The apparatus of claim 14, further comprising blocking a reporting of an error if the reported error is included in a list of previously reported errors.

26. The method of claim 14, further comprising reporting the error to an authorized user associated with the item listing.

27. A non-transitory computer-readable medium embodying instructions that, when executed by a processor, perform operations comprising:
obtaining an error report from a reporting user of the item listing; and
reporting the error to an authorized user associated with the item listing.

28. The non-transitory computer-readable medium of claim 27, further comprising validating the error.

29. The non-transitory computer-readable medium of claim 28, further comprising evaluating a severity of the validated error.

30. The non-transitory computer-readable medium of claim 29, further comprising:
comparing the severity of the validated error and a severity threshold value; and
correcting the reported error if the severity of the validated error is less than the severity threshold value.

31. The non-transitory computer-readable medium of claim 27, further comprising determining a trust level of the reporting user.
